(19) United States
(12) Patent Application Publication
(10) Pub. No.: US 2007/0089137 A1
(43) Pub. Date: Apr. 19, 2007

(54) Television interface system

(76) Inventor: Christopher M. Clark, Knoxville, TN (US)

Correspondence Address: LUEDEKA, NEELY & GRAHAM, P.C., P O BOX 1871, KNOXVILLE, TN, 37901, US

(21) Appl. No.: 11/253,195

(22) Filed: Oct. 18, 2005

(51) Int. Cl. H04N 5/445

(52) U.S. Cl. 725/51

(57) ABSTRACT

A digital media interface system combines video information from two video information sources to form a combination video signal for display on a television display device. One of the video information sources may be a digital media content provider, such as a satellite or cable television service provider, and the other video information source may be a personal computer connected to the Internet. The system generates a window of graphics information, such as from an Internet webpage, and overlays the window on a television screen along with the digital video provided by the satellite or cable television provider.

### FIELD

This invention relates to the field of digital media systems. More particularly, this invention relates to a system for combining television programming and Internet information on a single television screen.

### BACKGROUND

Increasingly, television programming is provided to consumers in a compressed digital format via cable, satellite or direct broadcast wireless signals. The leading standards for digital video compression are provided by the Moving Picture Experts Group (MPEG) and are referred to as MPEG-2 and MPEG-4. Generally, MPEG achieves a high compression rate by storing only the changes from video one frame to another, instead of each entire frame. The video information is then encoded, such as using direct cosine transform (DCT). MPEG uses a type of lossy compression, since some data is removed. But the diminishment of data is generally imperceptible to the human eye.

MPEG-2 offers resolutions of 720×480 and 1280×720 at 60 frames per second, with full CD-quality audio. MPEG-4 is a graphics and video compression algorithm standard that is based on MPEG-2 and Apple QuickTime technology. MPEG-4 is designed to transmit video and images over a narrower bandwidth than MPEG-2 and can mix video with text, graphics and 2-D and 3-D animation layers.

Although the MPEG and other video data compression standards are capable of providing television viewers high quality video images, the data stream is a “one way street.” These standards are not designed to provide television viewers an interactive viewing experience. Thus, other than switching channels and requesting pay-per-view movies, television viewers cannot truly interact with the television programming provided by cable and satellite television providers.

The Internet, on the other hand, allows users almost infinite interactive entertainment and information gathering opportunities. However, in general, the bandwidth at which Internet data is made available to users is considerably narrower than the bandwidth used by cable and satellite television providers. Thus, viewing real-time streaming video via the Internet, such as in MPEG-2 or MPEG-4 format, is not a practical option for most users.

What is needed, therefore, is a system for combining the high-quality streaming video information provided by cable and satellite television providers with the interactive entertainment, advertising and information gathering options provided by the Internet.

### SUMMARY

The above and other needs are met by a digital media interface system that combines video information from two video information sources to form a combination video signal for display on a television display device. In preferred embodiments of the invention, one of the video information sources is a digital media content provider, such as a satellite or cable television service provider, and the other video information source is a personal computer connected to the Internet. As described in more detail below, the system generates a window of graphics information, such as from an Internet webpage, and overlays the window on a television screen along with the digital video provided by the satellite or cable television provider.

In a most preferred embodiment, the system provides an interface controller and a graphics controller. The interface controller receives graphics information from a computing device, such as a computer, and generates a graphics information signal based on the graphics information. The graphics controller receives the graphics information signal from the interface controller and generates information window graphics based on the graphics information signal. The graphics controller also receives a digital media data stream containing video data, such as from a satellite or cable television provider, which the graphics controller combines with the information window graphics to form the combination video signal.

In a preferred embodiment, the digital media interface system includes the computer for generating the graphics information. The computer includes a network communication interface for providing communication between the computer and a communication network, such as the Internet. This embodiment also includes a data extractor for receiving the digital media data stream, for copying consumer-oriented data from the data stream and providing the consumer-oriented data to the interface controller. The interface controller receives the consumer-oriented data from the data extractor and provides it to the computer. The computer receives the consumer-oriented data, accesses information related to the consumer-oriented data from the communication network, and generates the graphics information based on the information accessed from the communication network.

In one preferred embodiment, the data extractor copies the consumer-oriented data which includes web page link information indicating a web page accessible via the communication network. The computer executes a browser application to access the web page indicated by the web page link information and generates the graphics information based on information accessed from the web page via the communication network. The graphics controller then generates the information window graphics based on the information accessed from the web page.

In another aspect, the invention provides a method for combining video information from two video information sources to form a combination video signal for display on a television display device. The method includes steps of (a) generating computer graphics information in a computing device, (b) generating information window graphics based on the computer graphics information, (c) receiving a digital media data stream containing video data from a digital media service provider and (d) combining the information window graphics with the video data from the digital media data stream to form the combination video signal in a format compatible for display on the television display device.

In a preferred embodiment, the method also includes steps of (e) copying consumer-oriented data from the digital media data stream and (f) accessing information related to the consumer-oriented data from a global communication network. In this embodiment, step (a) includes generating the graphics information based on the information accessed from the global communication network.

In some preferred embodiments, step (e) includes copying web page link information from the digital video data stream, where the web page link information indicates a web page accessible via the communication network. Step (f) of these embodiments includes executing a network browser application to access the web page indicated by the web page link, and step (a) includes generating the computer graphics information based on information accessed from the web page. Step (d) preferably includes displaying the information window graphics in a window that overlays the video from the digital media data stream.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a digital media interface system according to a preferred embodiment of the invention;

FIG. 2 depicts a television/computer interface portion of a digital media interface system according to a preferred embodiment of the invention;

FIG. 3 depicts a computer portion of a digital media interface system according to a preferred embodiment of the invention;

FIG. 4 depicts a digital media interface system according to an alternative embodiment of the invention;

FIGS. 5-7 depict a television/computer interface portion of a digital media interface system according to alternative embodiments of the invention;

FIG. 8 depicts further details of a digital media interface system according to a preferred embodiment of the invention;

FIG. 9 depicts a portion of an MPEG-2 digital media data stream according to a preferred embodiment of the invention;

FIGS. 10A-10C depict examples of television screen graphics generated by a digital media interface system according to a preferred embodiment of the invention;

FIG. 11 depicts a digital media interface system according to another alternative embodiment of the invention; and

FIG. 12 depicts a method of operating a digital media interface system according to a preferred embodiment of the invention.

### DETAILED DESCRIPTION

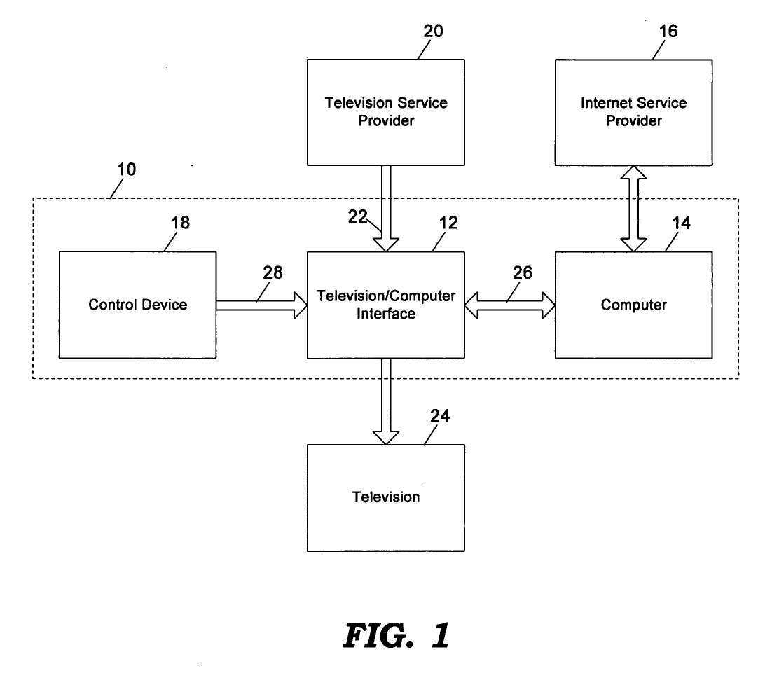

FIG. 1 depicts a preferred embodiment of a television interface system 10 according to the present invention. The system 10 includes a television/computer interface 12, a computer 14 connected to the Internet 16 and one or more remote control devices 18. The television/computer interface 12, which is also referred to herein as a set-top box (STB), receives a digital media signal from a television service provider 20, such as a satellite or cable television provider. The digital media signal is provided to the STB 12 via a connection 22 which may comprise a coaxial cable, an Ethernet connection, wireless signal or other means of signal transfer. As described in more detail hereinafter, the STB 12 decodes the digital media signal and provides it to a television viewing unit 24, such as a CRT, LCD or plasma monitor or a projector.

The STB 12 also receives a digital information signal from the computer 14 via a connection 26, which may be a wired or wireless local area network, Universal Serial Bus (USB) or direct bus connection, such as PCI. According to preferred embodiments of the invention, the STB 12 combines the digital information signal from the computer 14 with the digital media signal from the television service provider 20 to form a combined graphics signal. This combined signal is then provided to the television viewing unit 24.

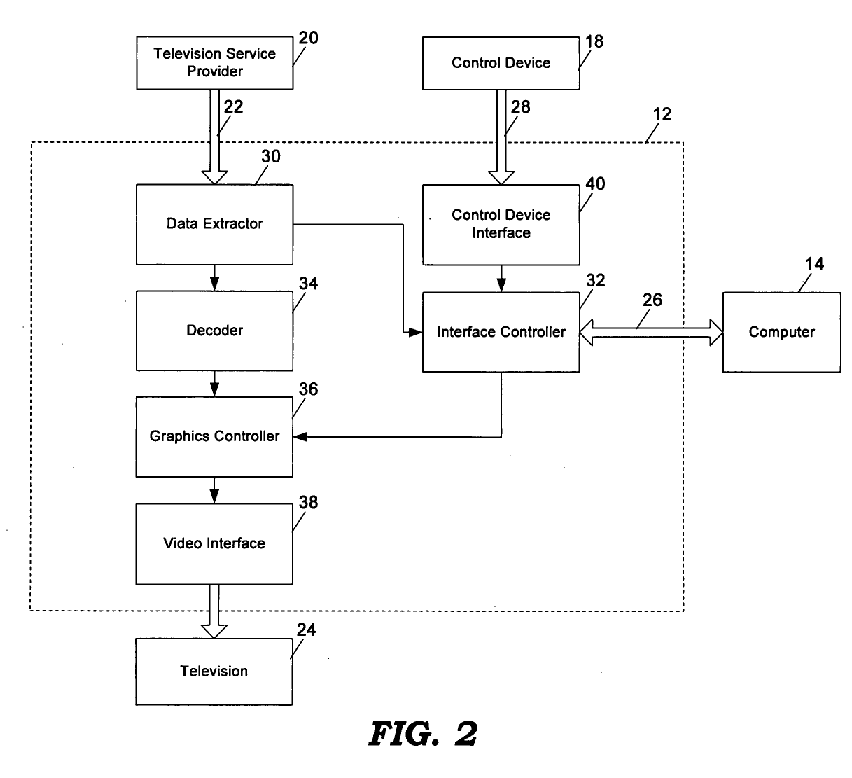

FIG. 2 depicts components of the STB 12 according to a preferred embodiment of the invention. The STB 12 includes a data extractor 30 that receives the digital media stream from the television service provider 20. Embedded in the digital media stream is “user data,” also referred to herein as “consumer-oriented data.” The purpose of the data extractor 30 is to extract or copy the user data and provide it to the computer 14.

User data may be present in the digital media stream 22 for various purposes, such as to identify the source of the associated video program or the particular type of software that was used to produce or encode the video data. As described in more detail hereinafter, user data may also be used to provide information to consumers regarding products or services depicted in the associated video program.

The user data is typically embedded in a user data section of the digital media stream. As described in more detail below, the data extractor 30 monitors the encoded digital media stream and “listens” for the beginning of a user data section. When a user data section is detected, the data extractor 30 copies the user data from the encoded data stream and passes it to an interface controller 32. The interface controller 32 sends the copied data from the data extractor 30 to the computer 14 over the connection 26. Although the user data is copied from the digital media stream as it passes through the data extractor 30, the digital media stream that enters the STB 12 on the connection 22 passes through the data extractor 30 substantially unaltered.

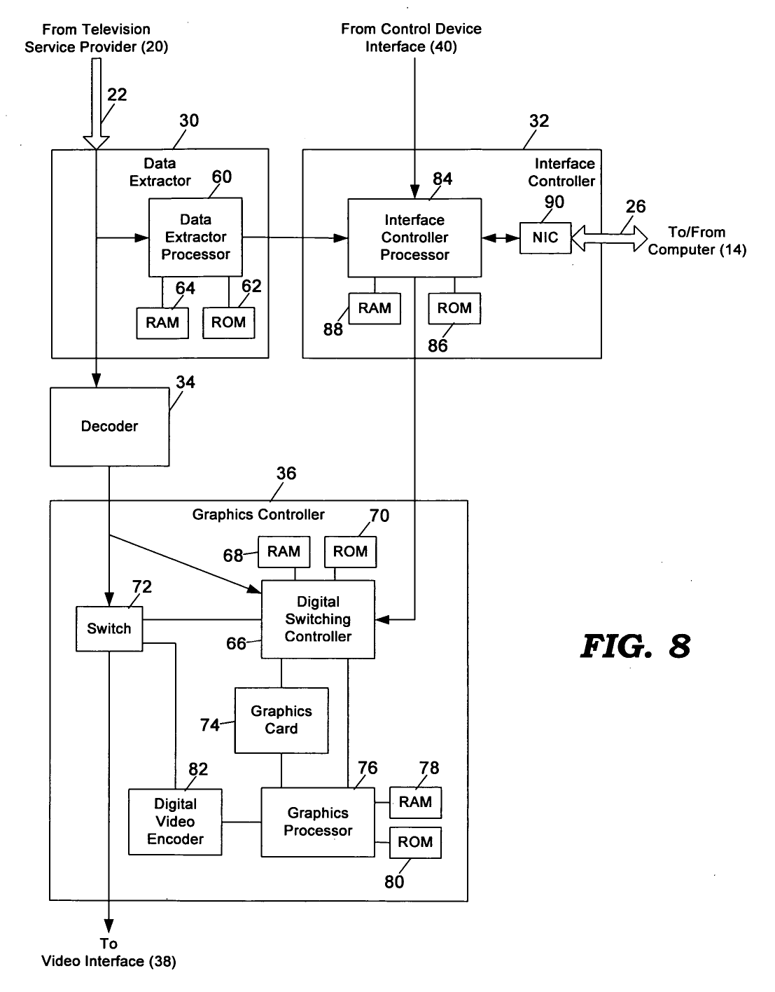

In preferred embodiments of the invention, the data extractor 30 functions as a listening port patched onto the digital media data stream 22. As shown in FIG. 8, the data extractor 30 includes a data extractor processor 60 that monitors the data stream 22 for sequences of the user data in the digital media signal. The data extractor 30 also include read-only memory (ROM) 62 for storing programming instructions and random access memory (RAM) 64 for temporary storage of data.

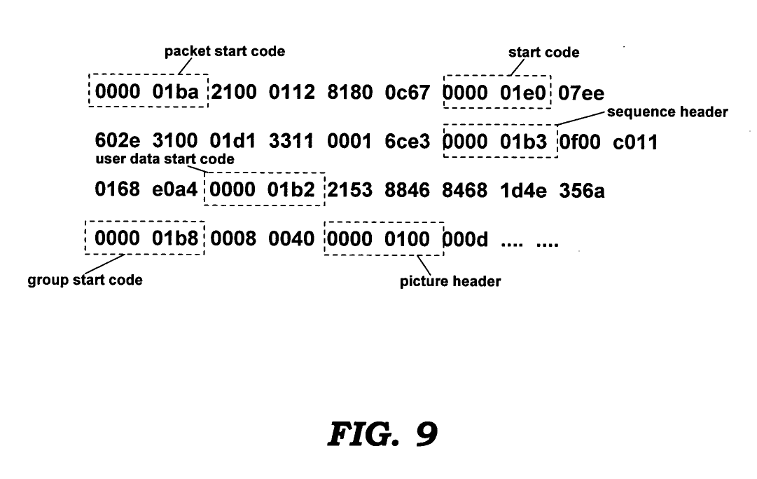

To provide background for describing the operation of the data extractor 30, the data format of an MPEG-2 data stream is first described with reference to FIG. 9, which represents typical MPEG-2 data in hexadecimal format. As shown in FIG. 9, an MPEG-2 data stream may include a number of different “start codes” that indicate the beginning of various portions of the data stream. According to the MPEG-2 standard for digital video as set forth in ISO/IEC 13818-2, start codes are specific bit patterns that do not otherwise occur in the video stream. Each start code consists of a start code prefix followed by a start code value.

According to the MPEG-2 standard, the start code prefix is a string of twenty three bits with the value of zero followed by a single bit with the value one. Thus, the start code prefix is the bit string “0000 0000 0000 0000 0000 0001” (0000 01 in hexadecimal). Immediately following the start code prefix is the start code value. The start code value is an eight bit integer that identifies the type of start code. Most types of start code have just one start code value.

The start code value for the “user data” portion of the MPEG-2 stream is “b2” in hexadecimal. Thus, as shown in FIG. 9, the hexadecimal value for the user data start code is “0000 01b2.” The actual user data comprises all the data in the data stream that follows the user data start code and precedes a stop code (or the next start code). The user data section can be of any length. In the example of FIG. 9, the user data comprises the string “2153 8846 8468 1d4e 356a.”

The SMPTE Registration Authority, LLC is currently authorized by the International Organization of Standardization (ISO) to register MPEG-2 format identifiers. The registration descriptor of MPEG-2 standard is provided by ISO 13818-1 to enable users of the MPEG-2 standard to unambiguously carry data when the format of the data is not necessarily a recognized international standard. This provision permits the MPEG-2 video transport standard to carry various types of data while providing for a method of unambiguous identification of the characteristics of underlying private data.

Entities that are registered with SMPTE are assigned a unique code that can be recognized in the video stream. Using this registration code, a registered entity can embed specific user data in the video data stream. The registration code can also be used to locate and extract the user data.

With reference to FIG. 8, the data extractor processor 60 listens for the user data start code (0000 01B2) in the MPEG-2 data stream Based on programming instructions stored in the ROM 62. Once the user data start code is detected, the processor 60 jumps to another section of programming in the ROM and begins listening for an appropriate registration code. When the registration code is detected, the processor 60 begins copying all the preceding data into the RAM 64 until a stop code is detected. The processor 60 forwards the data saved in the RAM 64 to the interface controller 32. The processor 60 then recycles and begins listening for the next user data start code.

After the video stream passes through the data extractor 30, a decoder 34, such as an MPEG-2 or MPEG-4 decoder, decodes the digital media stream into a pure digital luminance/chrominance (Y/C) signal. The decoded media signal is provided to a graphics controller 36 which combines the media stream data with graphics data from the computer 14, if it is instructed to do so. Finally, depending again on the application of the STB 12 and the type of television viewing device 24 in use, the digital media signal may be converted into an analog signal in a video interface 38. Thus, depending on the particular embodiment of the invention, the signal provided to the television viewing device 24 may be component video, composite video, Digital Visual Interface (DVI), High-Definition Multimedia Interface (HDMI) or other video or multimedia format.

As discussed in more detail hereinafter, the computer 14 sends graphics data and commands via the connection 26 to the interface controller 32. The interface controller 32 relays the graphics data from the computer 14 to the graphics controller 36. The graphics controller 36 embeds the graphics data from the computer 14 into the original digital media stream that passed through the data extractor 30. The graphics controller 36 also develops the appropriate graphics for display on the television viewing device 24 based on the combined digital media and computer graphics signals.

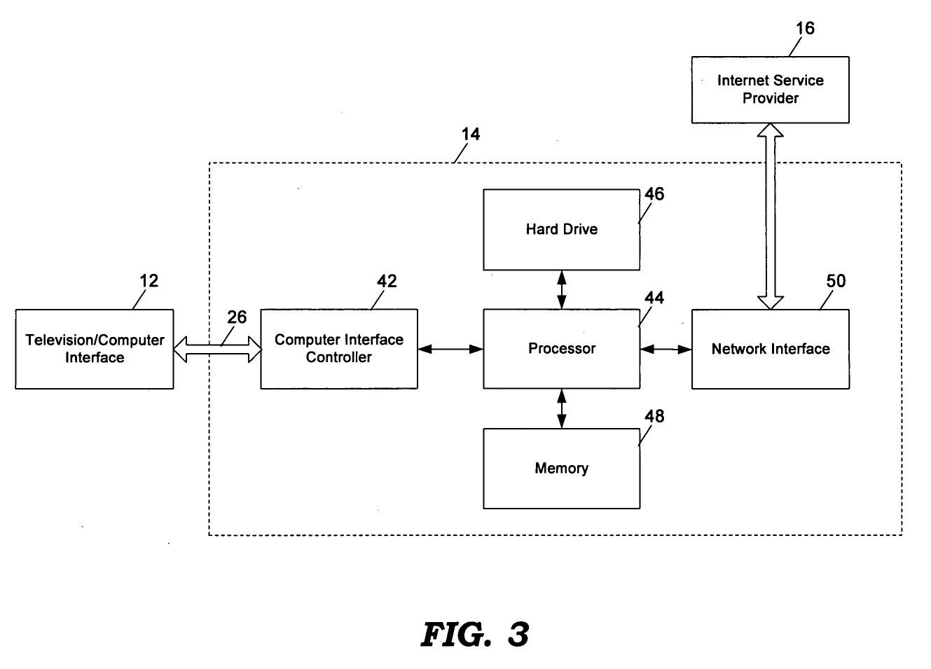

FIG. 3 depicts a preferred embodiment of the computer 14, which comprises a computer interface controller 42, a processor 44, a hard drive 46, memory 48 and a communication network interface 50. The interface controller 42 may be a local area network interface card, a USB controller or an address/data bus, such as a PCI bus. The interface controller 42 provides the data interface between the STB 12 and the processor 44.

Using the hard drive 46 and the memory 48, the processor 44 processes the data from the STB 12 depending on the type of data received. If the data is a request for an Internet link to be shown on the television display device 24, the processor 44 uses browser software to fetch the requested link data via the network interface 50. Based on the link data, the processor 44 generates graphics instructional data and provides the graphics instructional data to the computer interface controller 42 to be sent to the STB 12 via the connection 26.

The interface controller 32 of the STB 12 receives the graphics instructional data from the computer interface controller 42 and provides this data to the graphics controller 36. As described in further detail below, the graphics instructional data provides information to the graphics controller 36 regarding how to display the link information that was requested. Based on the graphics instructional data, the graphics controller 36 develops the appropriate link graphics and embeds the link graphics into the digital video stream. For example, the link graphics may comprise a computer “window” displaying a web page corresponding to the link information. This window is shown on the television display device 24 as an overlay on the original digital video signal. In the preferred embodiment, the overlaid computer window appears on the display device 24 the same manner as it would in a browser window displayed on a computer screen.

As shown in FIG. 8, the interface controller 32 includes an interface controller processor 84 that is in communication with to the control device interface 40, data extractor 30 and graphics controller 36. The control device interface 40 and the data extractor 30 provide data to the processor 84 which operates on the data based on instructions stored in the ROM 86. These instructions determine how the processor 84 is to modify the input data so that it can be sent to the network interface card (NIC) 90 and on to the computer 14 in a format that can be understood by software running on the computer 14. After the data is modified appropriately, it is stored to the RAM 88 until it is sent to the NIC 90.

Preferably, these operations work in the same manner in reverse. When the NIC 90 receives data from the network 26, it sends the data to the processor 84. The processor 84 then uses instructions from the ROM 86 to modify the data appropriately to send it on to the graphics controller 36. The modified data is then stored in the RAM 88 until the proper time to be forwarded to the graphics controller 36.

As shown in FIG. 8, the graphics controller 36 provides a system for generating graphics and embedding them synchronously into the digital media stream. In a preferred embodiment of the invention, the graphics controller 36 includes a digital switching controller 66 with associated RAM 68 and ROM 70, a data switch 72, graphics card 74, graphics processor 76 with associated RAM 78 and ROM 80, and a digital video encoder 82.

In the preferred embodiment, the digital switching controller 66 receives its instructions from the interface controller 32 and divides those instructions into graphics instructions and embedding instructions. The digital switching controller 66 forwards the graphics instructions to the graphics card 74 and saves the embedding instructions in RAM 68.

The digital switching controller 66 is also responsible for monitoring the digital media signal that passes through the data extractor 30, preferably in the same manner as the data extractor 30 monitors the digital media signal 22. The digital switching controller 66 monitors the digital media signal for the appropriate location in the data stream to activate the switch 72 to allow graphics to be embedded in the stream. This embedding location is determined based on the embedding instructions that were stored in RAM 68. In a normal mode, the switch 72 allows the digital media signal to pass unaltered. When the switch 72 receives appropriate instructions from the digital switching controller 66, the switch 72 is operated in a graphics insertion mode wherein graphics created in the graphics processor 76 are synchronously inserted into the video stream. In the preferred embodiment, this synchronous switching is accomplished using switching logic gates in the switch 72. An example of a similar switching scheme is that used in cable or satellite set-top boxes to insert programming guide graphics into a video signal along with an incoming video program signal.

In the preferred embodiment, the graphics card 74 operates in the same manner as graphics cards used in personal computers. The graphics card 74 receives the graphics instructions from the digital switching controller 66 in a format which is the same as, or very similar to, the format such instructions would be provided by a personal computer. Thus, in the preferred embodiment, the graphics card 74 perceives that the graphics instructions came directly from the computer 14.

Based on the graphics instructions from the digital switching controller 66, the graphics card 74 outputs the graphics data that the graphics processor 76 copied to its RAM 78. The graphics processor 76 then waits for a signal from the digital switching controller 66 that it is time to embed the graphics data into the digital media signal. When the digital switching controller 66 tells the graphics processor it is time to embed the graphics data, it either tells the graphics processor 76 how much data it is going to embed or it tells the graphics processor 76 when to stop.

When the graphics processor 76 is instructed to embed the graphics data, it outputs the data to the digital video encoder 82 which converts the data to the appropriate video format. For example, if the graphics card 74 created the graphics data in RGB format, the digital video encoder 82 converts the data into digital video luminance/chrominance (Y/C) format. The digital video encoder 82 then outputs the data to the switch 72 which embeds the graphics data into the digital media signal.

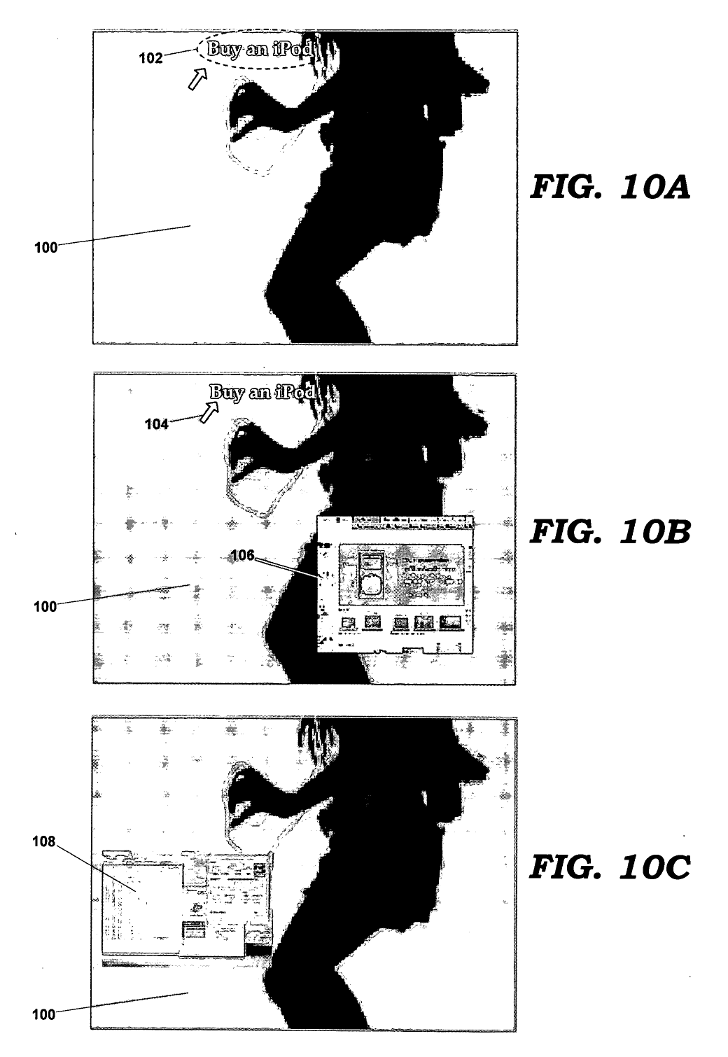

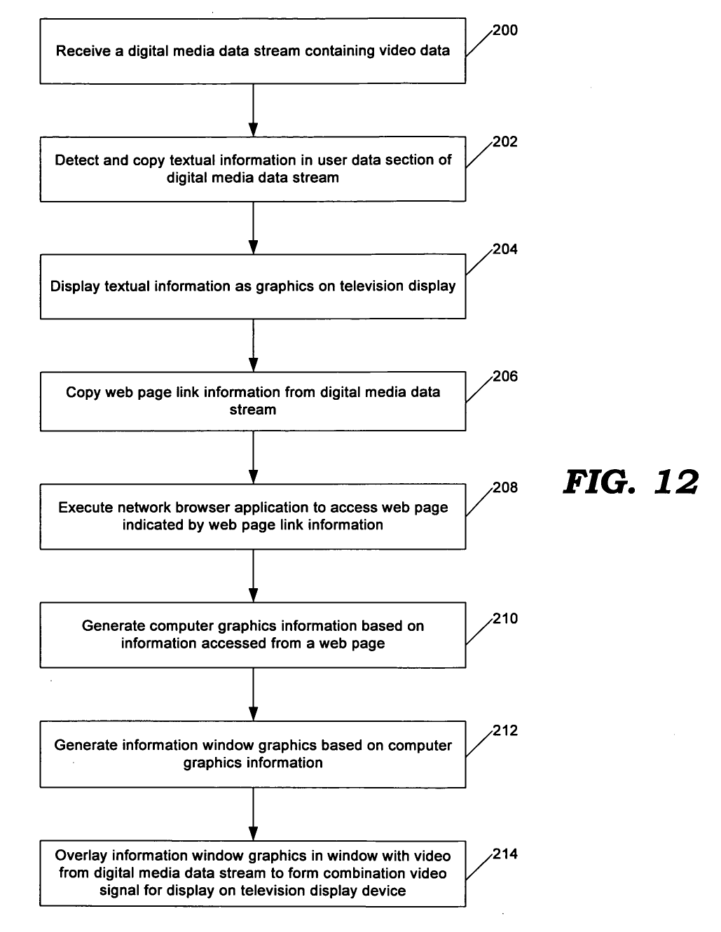

FIGS. 10A and 10B depict an example of television screen graphics generated by a preferred embodiment of the invention. FIG. 12 depicts steps performed in generating the screen graphics of FIGS. 10A and 10B. As shown in FIG. 10A, while receiving a video data stream depicting a television advertisement 100 for an Apple IPod (step 200 in FIG. 12), the data extractor 30 detects and copies user data in the video data stream that includes the textual phrase “Buy an iPod” (step 202). Based on this user data, the graphics controller 36 generates a graphical representation of the same textual phrase and embeds it in the digital media signal as described previously. As a result, the graphical representation 102 of “Buy an iPod” appears on the television display along with the video information for the television advertisement 100 (step 204).

In this example, the user data detected by the data extractor 30 also includes link information about a website where a consumer may obtain further information and/or purchase an iPod. This link information may be provided as a URL or an IP address. When detected, the link information is copied and sent to the interface controller 32 which provides the information to the computer 14 (step 206).

When a user sees the text graphics 102 appear on the television screen, this indicates to the user that further information regarding the advertised product is available on the Internet. To access that product information, the user presses a button on a remote control device 18 (see FIG. 2) to activate the interface controller 32 to send a request signal to the computer 14. In response to the request signal, the computer 14 accesses the associated web site, such as using a browser application (step 208). In an alternative embodiment, the user may use a mouse, touch pad or remote control, to position a curser 104 to click on the text graphics 102 which activates the interface controller 32 to send the request signal to the computer 14.

Continuing the example of FIGS. 10A and 10B, the computer 14 then accesses the web site and provides graphic information for generating the web page to the interface controller 32 (step 210). As described above, the interface controller 32 provides the web page graphics information to the graphics controller 36 which embeds the web page graphics into the digital media stream (step 212). As shown in FIG. 10B, the web page then appears in a window 106 on the television display device (step 214). Using the control device 18, the interactive functions provided in the web page window 106 may then be accessed in the same manner as if the web page were being viewed on a computer display connected directly to the computer 14. At the same time, the video program 100 continues on the television display “behind” the window 106.

According to a preferred embodiment of the invention, the graphical “relay” provided by the interface controller 32 and the graphics controller 36 also allows a user to view on the television display device 24 the graphics generated by any computer application running on the computer 14. In this manner, the user may take advantage of all the computer's functionality from in front of the television display device 24, such as word processing or email applications, or a full desktop environment. FIG. 10C depicts an example of the computer desktop displayed in a window 108 as a video program 100 continues on the television display “behind” the window 108.

In the preferred embodiment of the invention, the control device 18 comprises one or more USB control devices, such as a keyboard, touchpad, mouse, remote control or other user interface unit used to control the functionality of the STB 12 or the computer 14 or both. In the preferred embodiment, the control device 18 includes a USB keyboard and mouse. The control device 18 communicates via a connection 28 with a control device interface 40 in the STB 12. The connection 28 may be either wireless, such as infrared or RF, or wired. The control device interface 40 provides the control commands to the interface controller 32 which communicates the commands to the computer 14. Interface software running on the computer 14 allows the control device 18 to function with the computer 14 as if it was connected directly to the computer. Commands from the control device 18 can also trigger graphics to appear on the television display device 24.

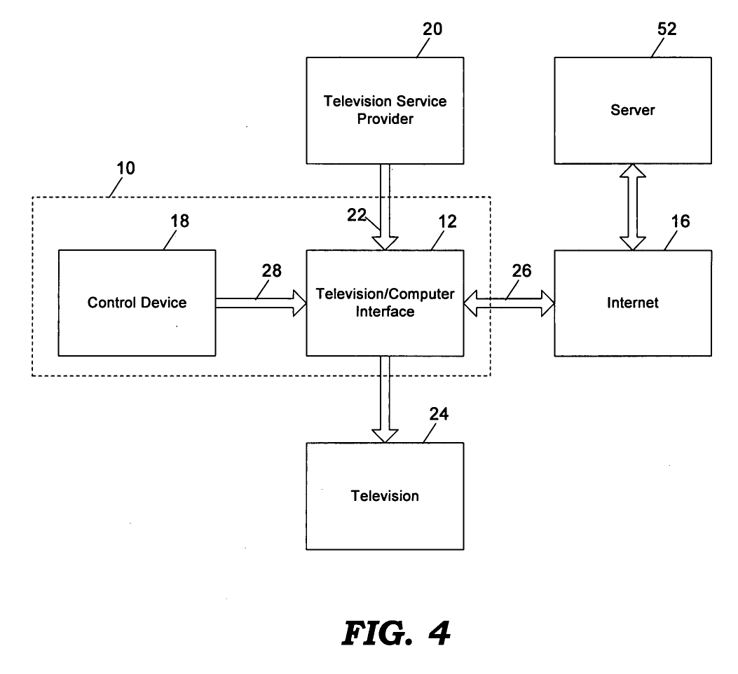

In an alternative embodiment of the invention depicted in FIG. 4, instead of being connected to a personal computer over a local area network, the STB 12 is connected to an off-site server computer 52 over a communication network 54, such as the Internet or a virtual private network. In this embodiment, the connection 26 is an Internet or VPN connection to a cable modem in the interface controller 32 of the STB 12. The server 52 provides many of the same services as provided by the computer 14 of the embodiment depicted in FIGS. 1, 2 and 3. In this alternative embodiment, however, the server 52 provides access to the Internet and email for users that do not have a personal computer.

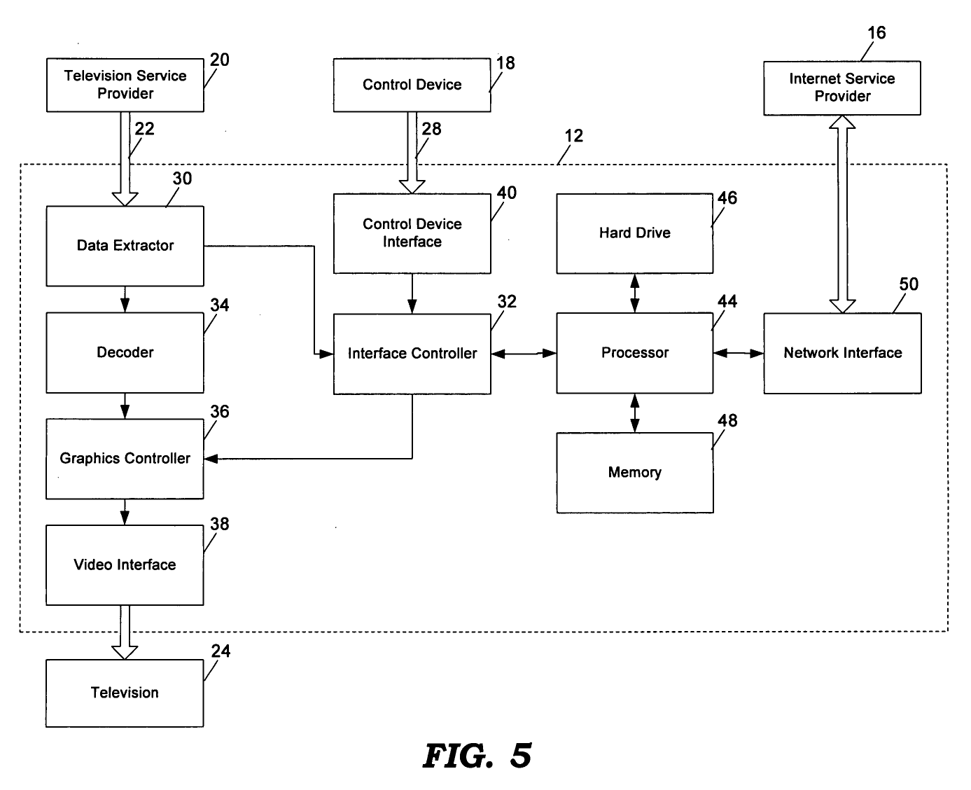

In another alternative embodiment of the invention, the components of the computer 14 are incorporated into the STB 12. As shown in FIG. 5, the processor 44 of this embodiment communicates directly with the interface controller 32, such as via a PCI bus. Otherwise, this embodiment functions in the same manner as the system depicted in FIGS. 1, 2 and 3.

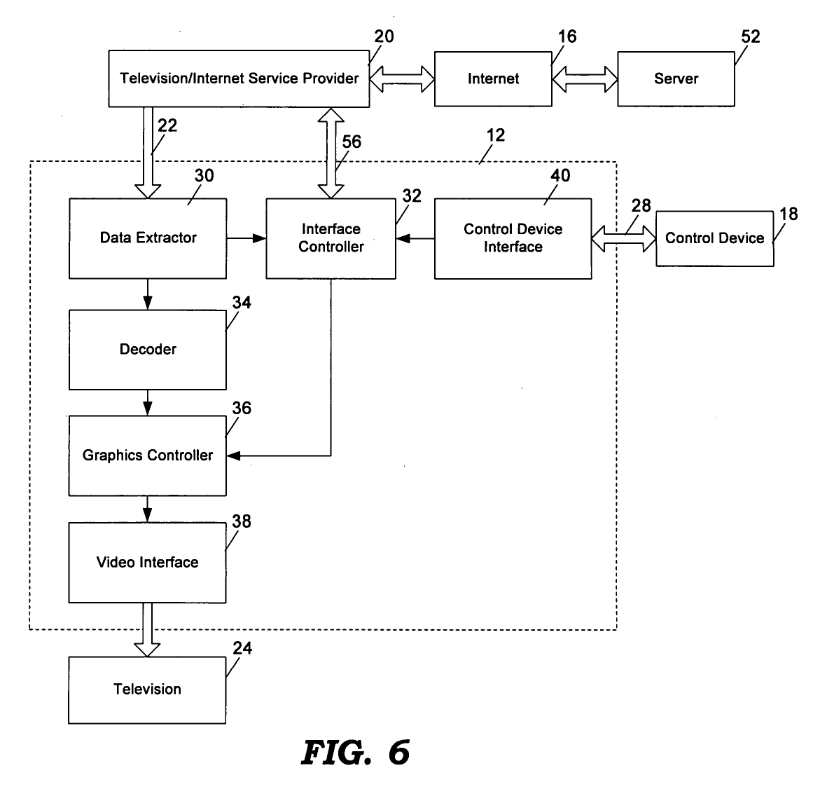

In another alternative embodiment depicted in FIG. 6, the interface controller 32 of the STB 12 accesses the Internet via a two-way interface provided by the television service provider, such as through a cable or satellite modem connection 56. In this embodiment, the interface controller 32 connects to the television service provider 20 which provides an Internet or VPN connection to an off-site server 52.

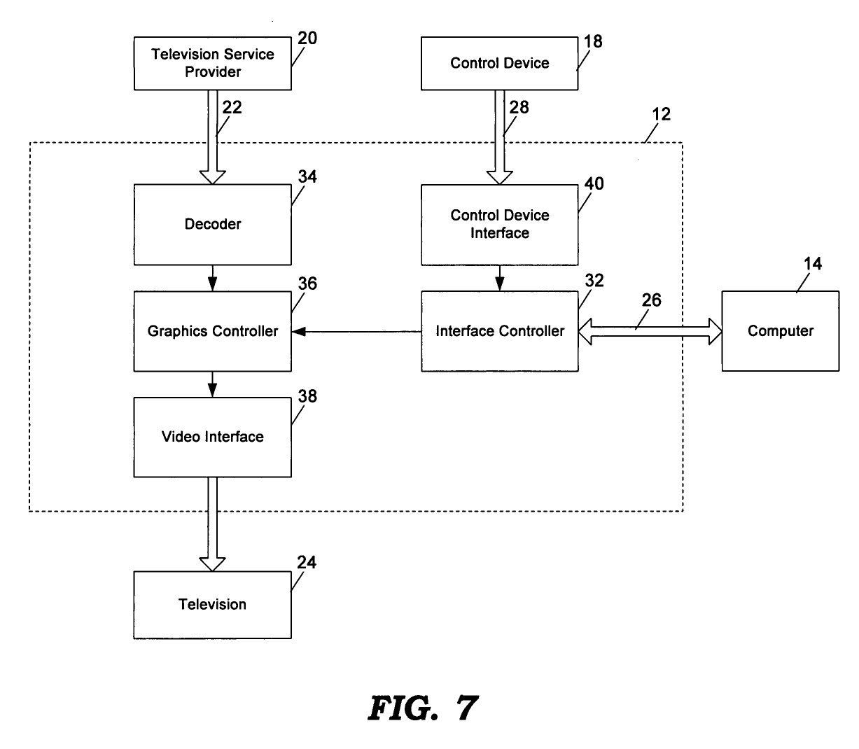

Yet another embodiment of the invention is depicted in FIG. 7. This embodiment functions in substantially the same manner as the embodiment of FIG. 2 except that no consumer oriented data is extracted from the digital media stream. Thus, any graphics the user chooses to display in the window overlaid on the screen of the display device 24 is not necessarily related to any consumer information in the digital media stream.

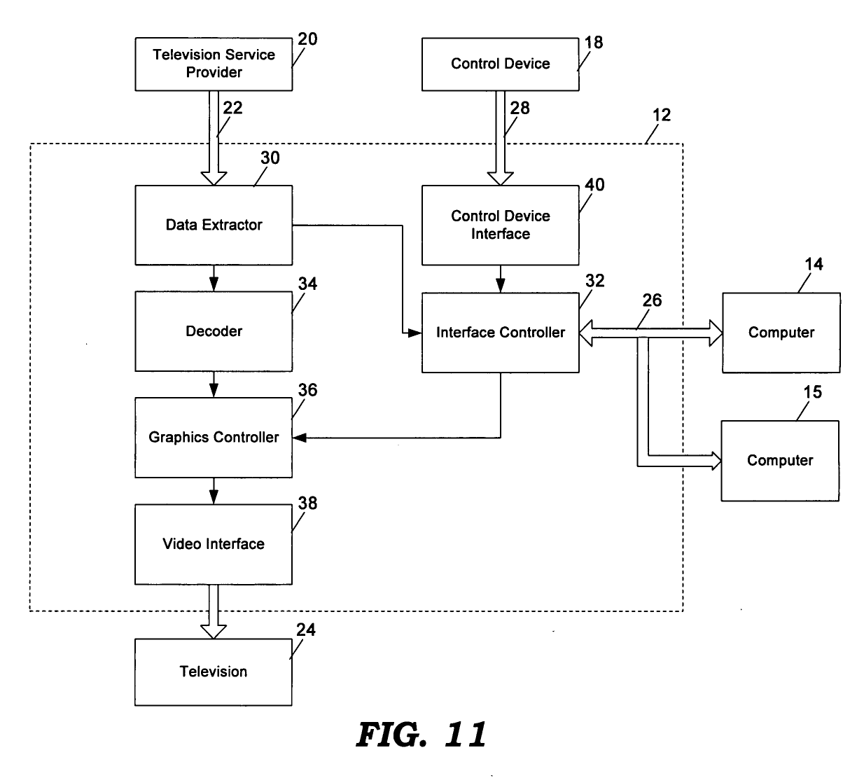

In an embodiment of the invention depicted in FIG. 11, the computer 14 is in communication with a second computer 15, such as a portable laptop computer, so that the computer 14 can send the website data to the second computer 15. For example, using the embodiment of FIG. 11, a user may be watching a television program while surfing the web on the computer 15 at the same time. When link graphics, such as the graphics 102 in FIG. 10A, appear on the television and the user clicks on the link graphics 102 using the interface device 18, instead of displaying the web page on the television, the web page is displayed on the screen of the second computer 15. This function may be activated as an option that is selected in an on-screen setup menu provided on the television screen. In this embodiment, the computer 15 is running application software that can respond to the requests and information from television/computer interface 12. Thus, the computer 15 can send and receive data to and from the computer 14 and the television/computer interface 12.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A digital media interface system for combining video information from two video information sources to form a combination video signal for display on a television display device, the system comprising:
an interface controller for receiving graphics information from a computing device and generating a graphics information signal based on the graphics information;
a graphics controller for receiving a digital media data stream containing video data, for receiving the graphics information signal from the interface controller, for generating information window graphics based on the graphics information signal, and for combining the information window graphics with the video data from the digital media data stream to form the combination video signal in a format compatible for display on the television display device.

2. The digital media interface system of claim 1 further comprising:
a computer for generating the graphics information, the computer including a network communication interface for providing communication between the computer and a communication network;
a data extractor for receiving the digital media data stream and for copying consumer-oriented data from the digital media data stream;
the interface controller for receiving the consumer-oriented data from the data extractor and providing the consumer-oriented data to the computer; and
the computer further for receiving the consumer-oriented data, accessing information related to the consumer-oriented data from the communication network, and generating the graphics information based on the information accessed from the communication network.

3. The digital media interface system of claim 2 further comprising:
the data extractor for copying the consumer-oriented data comprising web page link information indicating a web page accessible via the communication network;
the computer further for executing a browser application to access the web page indicated by the web page link information, and for generating the graphics information based on information accessed from the web page via the communication network; and
the graphics controller for generating the information window graphics based on the information accessed from the web page.

4. The digital media interface system of claim 2 further comprising a decoder for receiving the digital media data stream from the data extractor in an encoded format and for decoding the digital media data stream.

5. The digital media interface system of claim 1 wherein the graphics controller forms the combination video signal comprising a graphics window overlaid on the video from the digital media data stream.

6. The digital media interface system of claim 1 further comprising:
a remote control device for generating control signals to control operation of the digital media interface system;
a control device interface for receiving the control signals and providing the control signals to the interface controller; and
the interface controller for receiving the control signals and generating the graphics information signal based at least in part on the control signals and the graphics information.

7. The digital media interface system of claim 3 further comprising:
a remote control device for generating control signals to control operation of the digital media interface system;
a control device interface for receiving the control signals and providing the control signals to the interface controller;
the interface controller for receiving the control signals and providing the control signals to the computer; and
the computer for executing the network browser application based at least in part on the control signals.

8. The digital media interface system of claim 7 wherein the user control device comprises a device selected from the group consisting of a computer keyboard and a computer mouse.

9. The digital media interface system of claim 2 wherein the data extractor and the graphics controller receive the digital media data stream in an MPEG standard format.

10. The digital media interface system of claim 1 further comprising:
a computer for executing a software application that generates application graphics information;
the interface controller for receiving the application graphics information and generating an application graphics information signal based on the application graphics information;
the graphics controller for receiving the application graphics information signal from the interface controller and for forming an application graphics video signal in a format compatible for display on the television display device.

11. A digital media interface system for combining video information from two video information sources to form a combination video signal for display on a television display device, the system comprising:
data extraction means for copying consumer-oriented data from a digital media data stream;
computer means for providing communication with a communication network, for receiving the consumer-oriented data, for accessing information related to the consumer-oriented data from the communication network, and for generating graphics information based on the information accessed from the communication network;
graphics control means for receiving the graphics information, for generating information window graphics based on the graphics information, for receiving the digital media data stream containing video data, and for combining the information window graphics with the video data from the digital media data stream to form the combination video signal in a format compatible for display on the television display device.

12. The digital media interface system of claim 11 further comprising interface control means for receiving the graphics information from the computer means and providing the graphics information to the graphics control means, and for receiving the consumer-oriented data from the data extraction means and providing the consumer-oriented data to the computer means.

13. The digital media interface system of claim 11 further comprising:
the data extraction means for copying the consumer-oriented data comprising web page link information indicating a web page accessible via the communication network;
the computer means further for executing a network browser application to access the web page indicated by the web page link information, and for generating the graphics information based on information accessed from the web page via the communication network; and
the graphics control means for generating the information window graphics based on the information accessed from the web page.

14. The digital media interface system of claim 11 wherein the graphics control means form the combination video signal comprising a graphics window overlaid on the video from the digital media data stream.

15. A method for combining video information from two video information sources to form a combination video signal for display on a television display device, the method comprising:
(a) generating computer graphics information in a computing device;
(b) generating information window graphics based on the computer graphics information;
(c) receiving a digital media data stream from a digital media service provider, the digital media data stream containing video data;
(d) combining the information window graphics with the video data from the digital media data stream to form the combination video signal in a format compatible for display on the television display device.

16. The method of claim 15 further comprising:
(e) copying consumer-oriented data from the digital media data stream;
(f) accessing information related to the consumer-oriented data from a global communication network; and
step (a) further comprising generating the graphics information based on the information accessed from the global communication network.

17. The method of claim 16 wherein:
step (e) further comprises copying web page link information from the digital video data stream, the web page link information indicating a web page accessible via the communication network;
step (f) further comprises executing a network browser application to access the web page indicated by the web page link information; and
step (a) further comprises generating the computer graphics information based on information accessed from the web page via the communication network.

18. The method of claim 15 wherein step (d) further comprises overlaying the information window graphics in a window on the video from the digital media data stream.
